(19) United States
(12) Patent Application Publication
(10) Pub. No.: US 2002/0095576 A1
(43) Pub. Date: Jul. 18, 2002

(54) User recognition system

(76) Inventors: Robert Stoltz, Euless, TX (US); John Roosa, The Colony, TX (US); Robert Keim, Dallas, TX (US); Steven Groffman, Colleyville, TX (US)

Correspondence Address: Gardere Wynne Sewell, LLP, 3000 Thanksgiving Tower, Suite 3000, 1601 Elm Street, Dallas, TX, 75201-4767, US

(21) Appl. No.: 09/956,420

(22) Filed: Sep. 19, 2001

Related U.S. Application Data
(60) Provisional application No. 60/234,048, filed on Sep. 19, 2000.

(51) Int. Cl. H04L 9/00; H04L 9/32

(52) U.S. Cl. 713/175; 713/202

(57) ABSTRACT

The present invention provides a system, computer program and method for recognizing users by creating one or more certificates and issuing the one or more certificates to a first user. Each certificate has a certificate identifier and the first user has a first user identifier. The certificate identifier and the first user identifier for each certificate issued to the first user are stored in a database. At least one of the certificates given to a second user having a second user identifier by the first user is redeemed and the second user identifier is stored with the certificate identifier in the database for each certificate given to the second user.

### RELATED APPLICATIONS

This application claims priority based on a provisional patent application entitled USER RECOGNITION SYSTEM, serial No. 60/234,048 filed on Sep. 19, 2000.

### FIELD OF THE INVENTION

The present invention relates generally to the field of computer systems dealing with human resources, and more particularly, to an electronic web-based recognition system.

### BACKGROUND OF THE INVENTION

Employee recognition systems allow a company to recognize the good work of its employees. Such systems are designed to inspire employees to work harder and better because everyone appreciates a “pat on the back.” But these employee recognition systems have been limited to the recognition of employees by their supervisors or a non-management employee with prior approval of a supervisor or management level employee. Furthermore, the current systems allow a methodology for non-management and management to recognize higher levels (upward recognition) within the company without requiring prior management approval. Moreover, these recognitions systems were limited to employees within a single company or business unit within a larger company partly due to geographic constraints.

Accordingly, there is a need for a user recognition system that is not limited to the recognition of employees by their supervisors or to employees within a single company or business unit.

### SUMMARY OF THE INVENTION

The present invention provides a recognition system that gives a user a new way to recognize other users for a job well done. The present invention is not limited to the recognition of employees by their supervisors or to employees within a single company or business unit. Although the most common application of the present invention would be for employee-to-employee recognition in a business, the users may be members of a club, group, cooperative or other organization. In addition, the present invention allows employees from different divisions, subsidiaries or countries to recognize each other's valuable contribution to a company. For example, a front office employee of an airline could recognize a flight attendant, ticket agent or maintenance worker for doing their job well, or for being courteous or helpful. Unlike other systems, the present invention is not limited to the recognition of employees by their supervisors. The present invention allows users to recognize other users in any direction of supervision or to other organizations.

More specifically, the present invention provides a method for recognizing users by creating one or more certificates and issuing the one or more certificates to a first user. Each certificate has a certificate identifier and the first user has a first user identifier. The certificate identifier and the first user identifier for each certificate issued to the first user are stored in a database. At least one of the certificates given to a second user having a second user identifier by the first user is redeemed and the second user identifier is stored with the certificate identifier in the database for each certificate given to the second user.

In addition, the present invention provides a computer program embodied on a computer readable medium for recognizing users. The computer program includes a code segment for creating one or more certificates, each certificate having a certificate identifier, a code segment for issuing the one or more certificates to a first user having a first user identifier, a code segment for storing the certificate identifier and the first user identifier for each certificate issued to the first user in a database, a code segment for redeeming at least one of the certificates given to a second user having a second user identifier by the first user, and a code segment for storing the second user identifier with the certificate identifier in the database for each certificate given to the second user.

Moreover, the present invention provides a system for recognizing users, the system having a server computer, a database communicably linked to the server computer, at least one user device, and a network communicably linking the user device to the server computer. The server computer creates one or more certificates, each certificate having a certificate identifier, issues the one or more certificates to a first user having a first user identifier via one of the user devices, stores the certificate identifier and the first user identifier for each certificate issued to the first user in the database, redeems at least one of the certificates given to a second user having a second user identifier by the first user via one of the user devices, and stores the second user identifier with the certificate identifier in the database for each certificate given to the second user.

Other features and advantages of the present invention shall be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings in which corresponding numerals in the different figures refer to corresponding parts in which:

FIG. 1 is a block diagram showing a user recognition system in accordance with one embodiment of the present invention;

FIG. 2 is a block diagram depicting the display page hierarchy of the user recognition system in accordance with one embodiment of the present invention;

FIG. 3 is a flow chart depicting the operation of the user recognition system in accordance with one embodiment of the present invention;

FIG. 4 is a flow chart depicting the login process of the user recognition system in accordance with one embodiment of the present invention;

FIG. 5 is a flow chart depicting the download/print process of the user recognition system in accordance with one embodiment of the present invention;

FIG. 6 is a flow chart depicting the redemption process of the user recognition system in accordance with one embodiment of the present invention;

FIG. 7 is a flow chart depicting the report process of the user recognition system in accordance with one embodiment of the present invention;

FIG. 8 is an example of a page containing certificates printed out in accordance with one embodiment of the present invention;

FIG. 9 is an example of a user login page in accordance with one embodiment of the present invention;

FIG. 10 is an example of a user login page containing data provided by the user in accordance with one embodiment of the present invention;

FIG. 11 is an example of a certificate re-download/print page in accordance with one embodiment of the present invention;

FIG. 12 is an example of a certificate redemption page in accordance with one embodiment of the present invention;

FIG. 13 is an example of a certificate redemption page showing a successful redemption of a certificate in accordance with one embodiment of the present invention;

FIG. 14 is an example of a certificate print warning page showing that the user has printed the allotted number of certificates for a given time period in accordance with one embodiment of the present invention; and

FIG. 15 is an example of a winner list page in accordance with one embodiment of the present invention.

### DETAILED DESCRIPTION

While the making and using of various embodiments of the present invention are discussed herein in terms of a user recognition system, it should be appreciated that the present invention provides many applicable inventive concepts which can be embodied in a wide variety of specific contexts. In fact, the present invention can be used in any situation where a company, group, cooperative or other organization desires to promote member-to-member or employee-to-employee recognition of good work, good attitudes, helpfulness, special skills or other admirable and desirable actions. The specific embodiments discussed herein are merely illustrative of specific ways to make and use the invention and does not limit the scope of the invention.

The present invention provides a recognition system that provides a user a new way to recognize other users. The present invention is not limited to the recognition of employees by their supervisors or to employees within a single company or business unit. Although the most common application of the present invention would be for employee-to-employee recognition in a business, the users may be members of a club, group, cooperative or other organization. In addition, the present invention allows employees from different divisions, subsidiaries or countries to recognize each other's valuable contribution to a company. For example, a front office employee of an airline could recognize a flight attendant, ticket agent or maintenance worker for doing their job well, or for being courteous or helpful. Unlike other systems, the present invention is not limited to the recognition of employees by their supervisors. The present invention allows users to recognize other users in any direction of supervision or to other organizations. The present invention may be described as a “pure” any employee to any employee recognition and reward system. “Pure” is used in the sense that no supervisory or managerial approval is required at any point in the process. The present invention provides “any employee” to “any employee” recognition in a procedural, periodic, electronic methodology for any and all levels between any and all work groups.

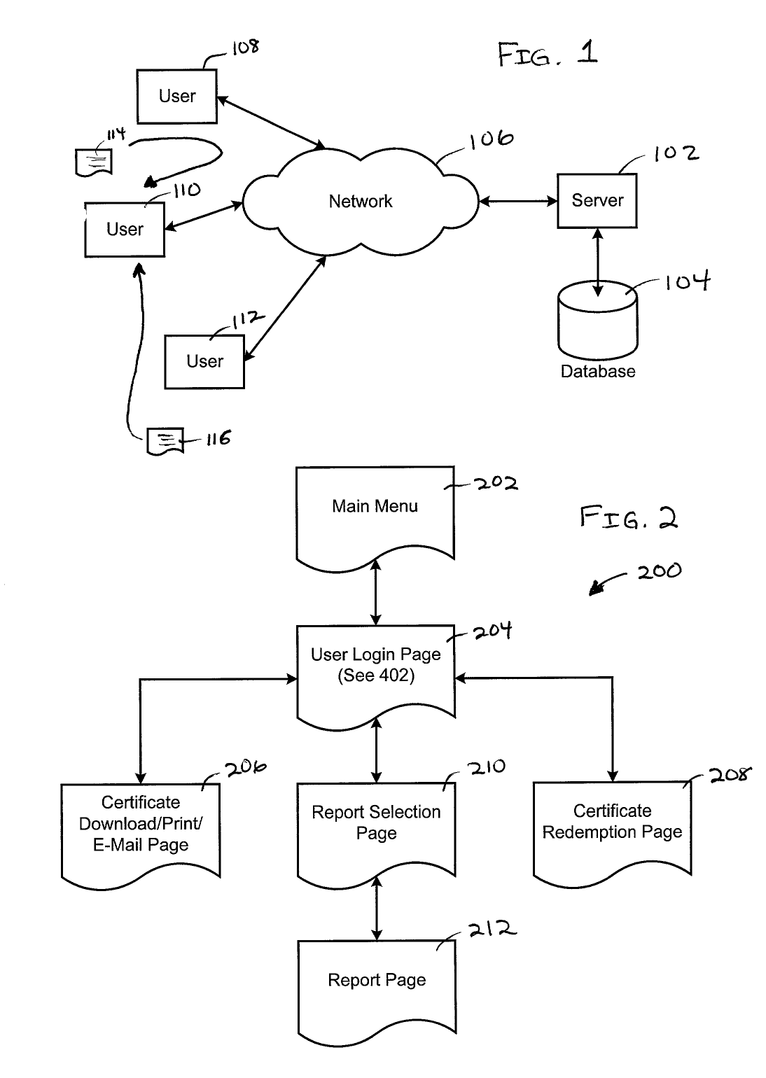

Referring to FIG. 1, a block diagram showing a user recognition system 100 in accordance with one embodiment of the present invention is shown. The user recognition system 100 contains a server computer 102 communicably connected to a database 104 and a network 106. The network 106 may be a dial-up connection, Intranet, Internet or any combination thereof that provides a communication link between the server 102 and users 108, 110 and 112. Users 108, 110 and 112 may access the network 106 with a device, such as a personal computer at their home or office, a laptop computer, a fixed terminal, a personal data assistant or a telephone using a touch tone processing system or a voice recognition and processing system. A secure communication protocol, such as SSL, will be used to send/request all sensitive data to/from the user's device. The server 102 will also have automated application security, configuration and customization.

The server computer 102 can be implemented on an OS/390-based Web server, Unix-based Web server, Intel-based Web server or any combination in between. The applications running on the server computer 102 can be written in HTML, DHTML, XML, XHTML, CGI, FastCGI, ASP, PHP, JSP, PERL, JAVA, Applets, Serviets, ColdFusion, etc. For example, one system could be a server environment of a shared MS Windows NT/2000 Server with ILS 3.0 (with ASP and SSL enabled) and SQL Server 7.x installed. HTML, DHTML, CSS 1, JavaScript and Adobe Acrobat Reader and MacroMedia Shockwave Flash plugins could then be used for the user interface. Business logic could be implemented via ASP written in VBScript using ADO to interface with DB2 through an ODBC data source using Neon System's Shadow Direct. The database 104 can be a middle tier MS SQL Server database implemented to tie content and user data into a single, personalized Web page for the user. Moreover, the database 104 may comprise a group of individual databases, look up tables or other means to store and retrieve data. Additionally, logic could be implemented to load and maintain a database of employee users or a facility from an ODBC connection to a database via mass load or individual screen.

The organization implementing the user recognition system 100 provides each user 108, 110 and 112 with a given number of certificates 114 and 116 during a specified period of time. The number and frequency of unique (by certificate number) certificates created are controlled by entered business processing rules within the software application. Exceptions to the specified number and frequency of certificates may be made for selected people or groups, such as a recognition group or an executive group. These selected people or groups may be given higher limits or possibly an unlimited number of certificates. For example, a user may obtain ten certificates per calendar month (see FIG. 8) via printer, e-mail or electronic file. The users 108, 110 and 112 then pass out these certificates 114 and 116, either physically or electronically, to recipients they wish to recognize. For example, user 108 could send certificate 114 to user 110 via network 106. Likewise, user 112 could physically give certificate 116 to user 110, assuming that user 112 generated certificate 116 using his or her password. Each recipient, such as user 110, can then redeem his or her certificates 114 and 116 for a chance in a periodic drawing of users that have redeemed their certificates during a given time period. Winners of the periodic drawing could be awarded money, gift certificates, merchandise, cars, trips or points that can be saved and used in the company's award program. The certificates 114 and 116 may optionally only be valid for a specified amount of time from the date of issue, such as one year. Thus, the user recognition system 100 will deactivate any certificates that are still outstanding past the specified amount out time.

The server 102 provides users 108, 110 and 112 with access to the system 100 and monitors the issuance and redemption of the certificates 112 and 114. The server 102 restricts the user's ability to create new certificates and ensures that any given certificate 112 and 114 can only be redeemed once. This restriction may be accomplished, for example, by limiting the creation and/or redemption to a specific, optimal time period. The server 102 assigns each certificate 112 and 114 with a unique certificate number, which may be alphanumeric, and the user's name and identification number, which also may be alphanumeric. The server 102 and related database 104 maintain the total number of certificates issued and the total number redeemed for the company, for specified divisions or groups, and for each user. The server 102 also deactivates any certificates 112 and 114 that have not been redeemed within a specified period of time. In addition, the server 102 and database 104 may optionally monitor supervisors to ensure that they are properly recognizing employees under their supervision or outside their supervision. The server 102 and database 104 also monitor the flow of certificates between users to check for abuse. For example, user 108 is giving all his or her certificates to user 110 and user 110 is giving all his or her certificates to user 108. All of this information is stored within one or more databases 104.

Database 104 may comprise a group of individual databases, look up tables or other data storage means that contain a variety of information, accessible and usable in a number of ways. For example, databases may be used to compare an employee number to an existing database of employees or to a database of employees created specifically for the program. Databases may also be generated for those who redeemed certificates (second users) and for those first users who created and presented recognition certificates. Moreover, databases may be generated for second user winners and corresponding first user presenters. In this case, there would be a new table for each new selection of winners. Winners can be automatically notified via e-mail or notified by a variety of other ways, such as by hard-copy, listing on the website or on-line messaging. The list of winners is also viewable via the website by selecting specific winners lists. The database 104 may also be sorted by a variety of criteria such as group/organization, period, and location.

Every so often, such as once a month, the server 102 will randomly select a specified number, a percentage, or all of the certificates from the currently available certificates (all active certificates redeemed for the month or other optionally selected period). Awards can be programmed such that everyone entering and/or redeeming a certificate is entered, a percentage of those redeeming certificates are be entered or a set number (any predetermined number of those entering and/or redeeming certificates) is entered. The user that received the selected certificate will be reported as a winner. The user that gave the selected certificate may optionally be reported as a winner. The implementing group may elect to provide awards for the first user (the person creating/presenting the certificate) on a one to one ratio, a percentage of first users or a set (predetermined) number. The present invention may also allow that for each second user winner, the corresponding first user (creator/presenter) also receives an award. Redeemed certificates are entered into periodic lotteries for awards. The periods are variable (for example, daily, weekly, monthly, quarterly and/or yearly) and can be selected by the implementing group. Winners of the periodic drawing could be awarded money, gift certificates, merchandise, cars, trips or points that can be saved and used in the company's award program (banked). Winners may be notified in a variety of ways, such as by hardcopy, listing on the website, on-line messaging or e-mail. The award levels are also variable and may be selected on a departmental level. Thereafter, the server 102 will deactivate all active certificates redeemed for the month, which were not randomly selected for the month. The user's receiving the most certificates during the month could also be recognized.

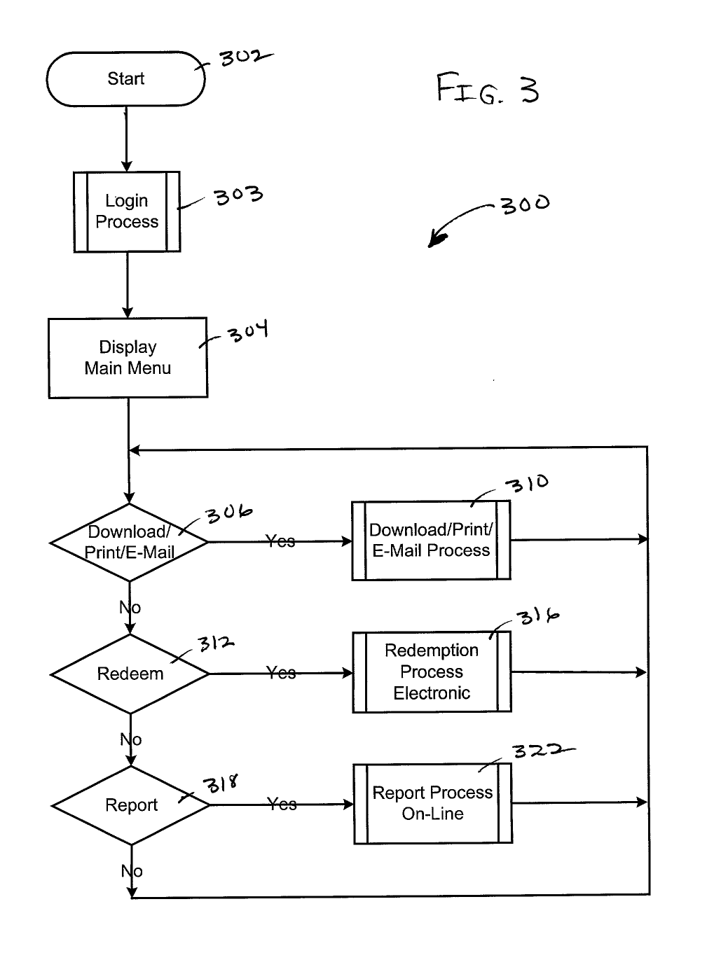

Referring to FIG. 2, a block diagram depicting the display page hierarchy 200 of the user recognition system in accordance with one embodiment of the present invention is shown. A user first accesses the user recognition system via a main menu 202. The main menu is a display or web page that contains options, which allows a user to choose to either download/print/e-mail certificates, redeem certificates or run reports. The main menu 202 may also include help and contact information, recognition system rules, administrative functions, such as password help, announcements and a list of previous winners. This information may be organized by period, group/organization, second user or first user, etc.

When the user selects to download/print/e-mail certificates, redeem certificates or run reports, the user will be presented with a user login page 204. The user login page 204 allows a user to access the certificate download/print/e-mail page 206, the certificate redemption page 208 or the report selection page 210. To access these pages 206, 208, 210, the user must successfully enter his or her user ID and password. The user ID could be the user's employee number, computer user ID or a name selected by the user. The password or PIN could be the last four digits of the user's social security number or other alphanumeric sequence randomly selected by the server 102 (FIG. 1) or the user. The server 102 (FIG. 1) will validate the ID and password entered by a user against the database 104 (FIG. 1). Any errors (Incorrect user ID and/or PIN, timeouts, etc.) are reported to user via an error page (not shown). After the login sequence is successful, the user will be presented with the selected page (certificate download/print/e-mail page 206, certificate redemption page 208 or report selection page 210). In addition, the user may freely navigate between the various pages using standard web browser functions after a successful login sequence.

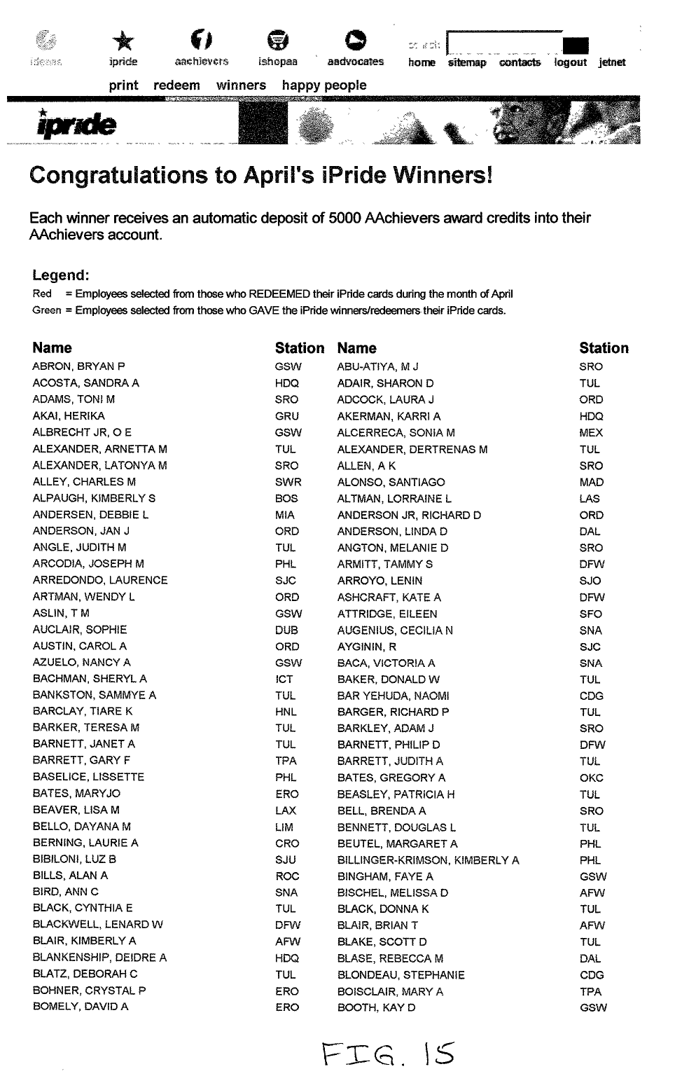

The certificate download/print/e-mail page 206 allows the user to view and download/print/e-mail certificates. The server 102 (FIG. 1) will validate that the user is eligible to download/print/e-mail new certificates against the database 104 (FIG. 1). The user will be allowed to print out or obtain electronic copies of a specified number of certificates within a specified period of time. For example, a user may be allowed to obtain six or ten certificates a month. If the user has already obtained his or her allotment of certificates, the user will only be allowed to obtain duplicate copies of the certificates already issued and will be issued a warning about duplicated numbers. This is illustrated in FIG. 14. The number of certificates could be set to the number of certificates that will fit on one 8½ by 11 inch page. Electronic mail (e-mail) copies will generally be sent by the first user to the second user on a one certificate to one message basis. The present invention also provides the ability to automatically create and send an e-mail with an “electronic card” attached that contains a graphic representation of one or more of the certificates to the recipient. The first user may include additional messages in the e-mail. Such an e-mail would also include the redemption information in text form so that a recipient or second user that does not have device graphically capable of displaying the card can still receive the necessary information to redeem the certificate. A confirmation that the “electronic card” was sent and/or received and/or redeemed can be automatically sent back to the first user. Errors (SQL errors, timeouts, etc.) will be reported to the user via an error message.

The certificate redemption page 208 allows a user to redeem any certificates he or she has received. In order to redeem a certificate, the user will provide their user ID (redeemer), the certificate issuer's user ID, which is printed on the certificate, and the certificate number, which is also printed on the certificate, for each certificate being redeemed. The server 102 (FIG. 1) will validate that each certificate is redeemable (valid user ID numbers, valid certificate number, active certificate, etc.) against the database 104 (FIG. 1). The database 104 (FIG. 1) may comprise more than one database, such as a database for the certificate information and a database for the user information. The certificates are ether successfully redeemed or an error message is presented to the user. Other errors (SQL errors, timeouts, etc.) will also be reported to the user via an error message or page.

Electronic messages may be automatically e-mailed to winners to notify them when and how (i.e., as a first or a second user) they won. The report selection page 210 contains options to allow authorized users to select various reports. Some reports, such as monthly winners or whether users receiving their certificates have redeemed them, may be available to all users, whereas other reports, such as detailed redemption reports may only be available to executives. The reports available to a given user can be determined via a security profile assigned to the user and stored in the database 104 (FIG. 1). Once a user selects an available report, the server delivers the report to the user via the report page 212.

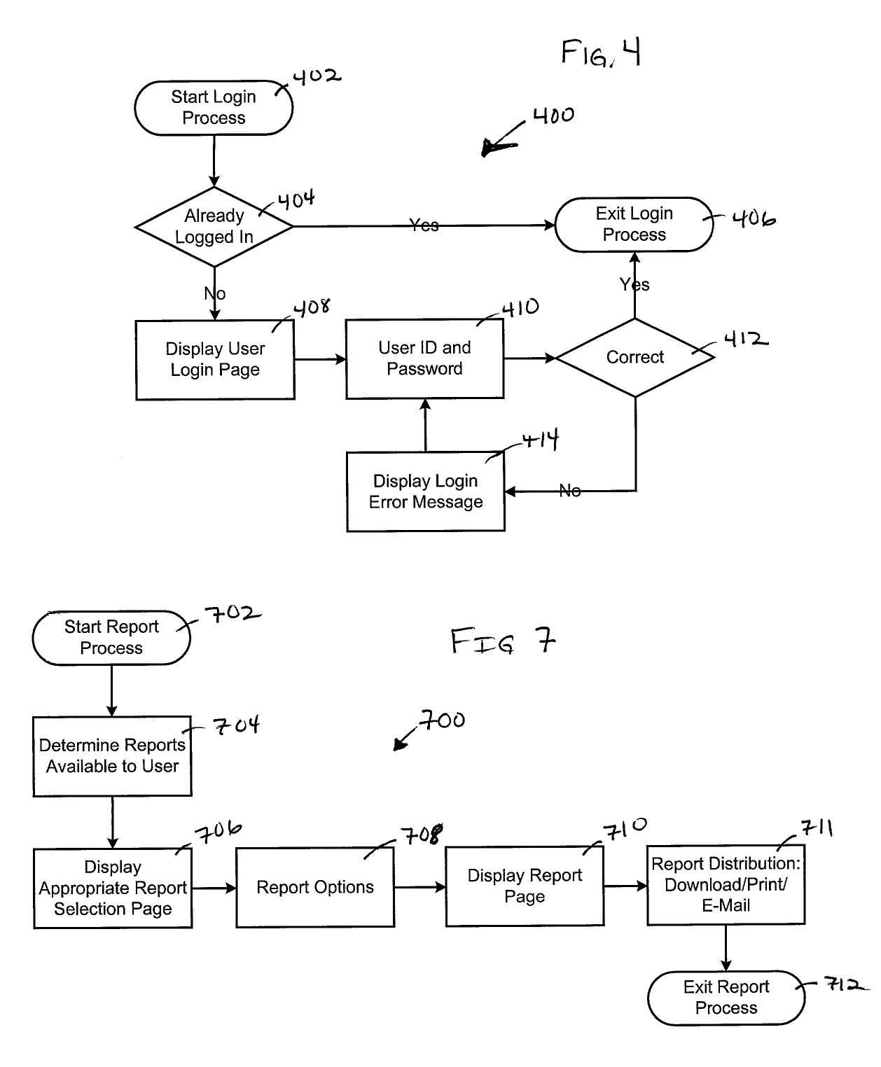

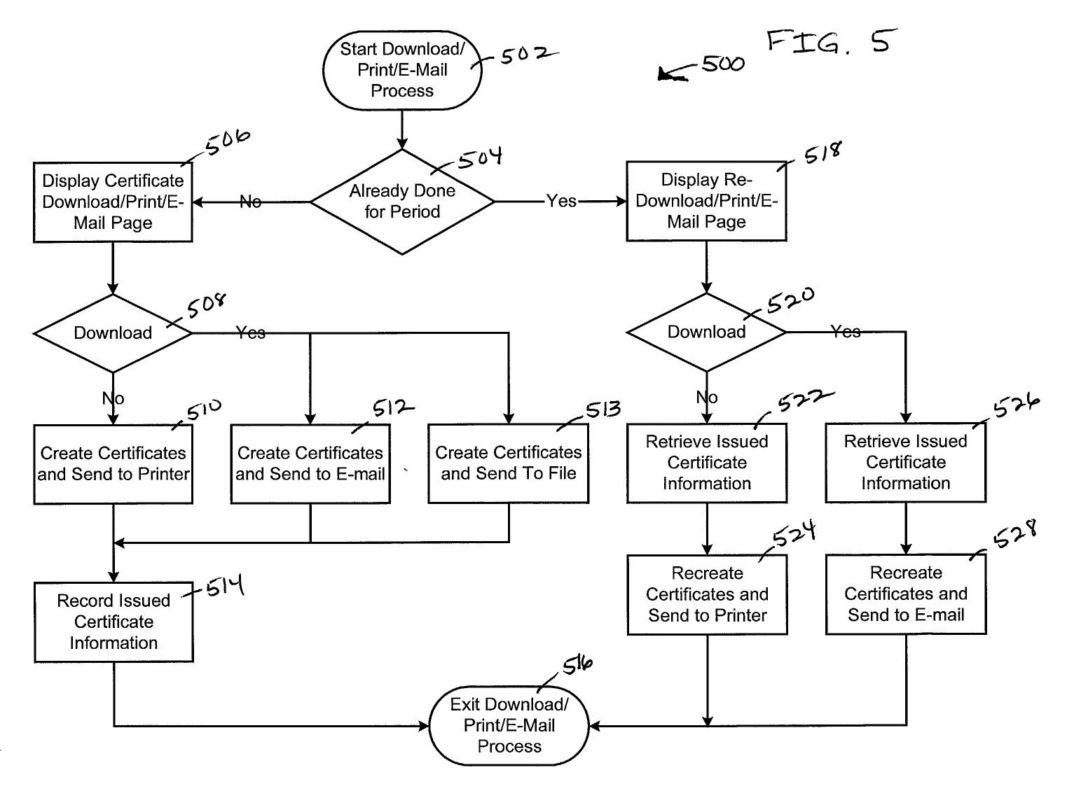

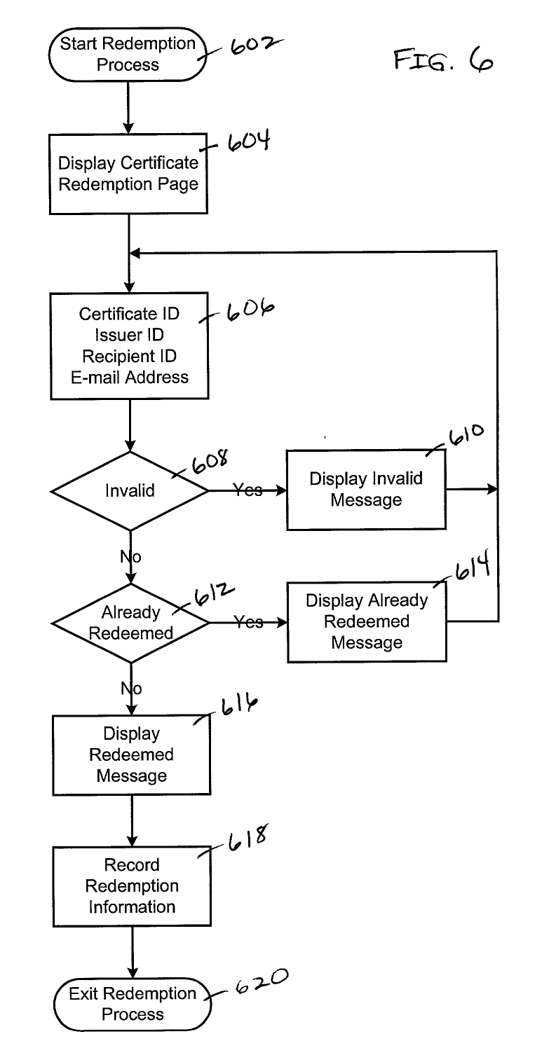

FIG. 3 is a flow chart depicting the operation of the user recognition system 300 in accordance with one embodiment of the present invention. The process start in block 302 and the main menu 202 (FIG. 2) is displayed in block 304 when a user accesses the user recognition system 300, after login in block 303, which is described in reference to FIG. 4. The main menu 202 (FIG. 2) may include administration functions, reset password function, forgot password function, contact information and help information. Thereafter, the user may select download/print/e-mail certificates, redeem certificates or obtain reports. If the user selects download/print/e-mail certificates, as determined in decision block 306, the print/download/e-mail process is initiated in block 310, which is described in reference to FIG. 5. Upon completion of the print/download/e-mail process, the process returns to decision block 306 where user may again select download/print/e-mail certificates, redeem certificates or obtain reports. Alternatively, the main menu can be displayed again in block 304.

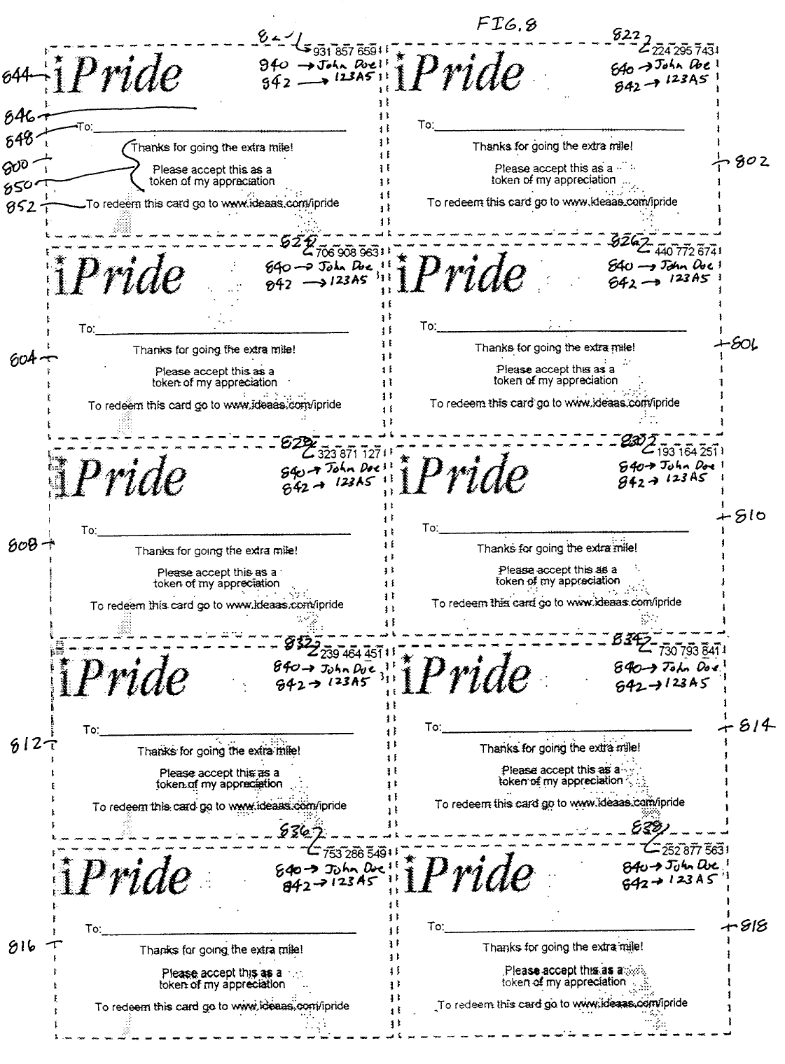

If the user selects redeem certificates instead of download/print/e-mail certificates, as determined in decision block 312, the redemption process is initiated in block 316, which is described in reference to FIG. 6. Upon completion of the redemption process, the process returns to decision block 306 where user may again select download/print/e-mail certificates, redeem certificates or obtain reports. Alternatively, the main menu can be displayed again in block 304.

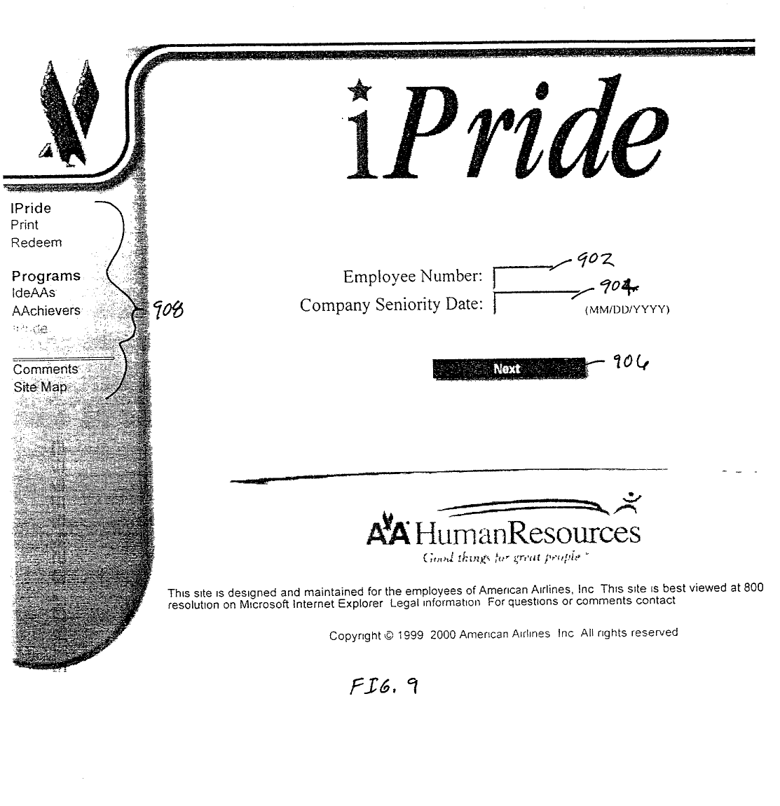

If the user selects reports instead of redeem certificates or download/print/e-mail certificates, as determined in decision block 318, the report process is initiated in block 322, which is described in reference to FIG. 7. Upon completion of the report process, the process returns to decision block 306 where user may again select download/print/e-mail certificates, redeem certificates or obtain reports. Alternatively, the main menu can be displayed again in block 304.

FIG. 4 is a flow chart depicting the login process 400 of the user recognition system in accordance with one embodiment of the present invention. The login process (see block 204 of FIG. 2 and block 303 of FIG. 3) begins in block 402. If the user is already logged in, as determined in decision block 404, the user exits the login process in block 406 and is returned back to the respective main process in FIG. 3, blocks 310, 316 or 322. If the user has not already logged in, as determined in decision block 404, the user login page 204 (FIG. 2) is displayed in block 408. The user then enters his or her user ID and password in block 410. If the user ID and password are correct, as determined in decision block 412, the user exits the login process in block 406 and is returned back to the respective main process in FIG. 3, blocks 310, 316 or 322. If the user ID and password are not correct, as determined in decision block 412, a login error message or page is displayed in block 414 and the user may then reenter his or her user ID and password in block 410.

Referring now to FIG. 5, a flow chart depicting the download/print process 500 of the user recognition system in accordance with one embodiment of the present invention is shown. The download/print/e-mail process (see block 310 of FIG. 3) begins in block 502. If the user has not downloaded or printed his or her certificates for the specified period, such as a month, as determined in decision block 504, the certificate download/print/e-mail page 206 (FIG. 2) is displayed in block 506. The user may then select to either download his or her certificates in electronic form, print out the certificates at his or her designated printer, or save the certificates to a file. The certificates may be printed in color or black and white. If the user selects print certificates, as determined in decision block 508, the server 102 (FIG. 1) creates and sends the certificates to the user's designated printer in block 510. The user can selected the message to be imprinted on the certificate from a list of predetermined messages or enter his or her own message during the certificate creation process or by editing the user's system options. If, however, the user selects download certificates, as determined in decision block 508, the server 102 (FIG. 1) either creates and sends the electronic certificates to the user typically via e-mail in block 512 or saves the certificates to a file in block 513, depending upon the choice of the user. After the certificates have been created and sent in either blocks 510 or 512 or saved in block 513, the server 102 (FIG. 1) records the issued certificate information in database 104 (FIG. 1) in block 514. The stored issued certificate information includes the certificate number assigned to each certificate by the server 102 (FIG. 1) and the user ID to which the certificate was delivered. Other information can also be stored, such as date and time information or data to be used later for statistical analysis. Thereafter, the user exits the download/print process in block 516 and is returned back to the main process in FIG. 3, block 304 or 306.

If, however, the user has downloaded or printed his or her certificates for the specified period, as determined in decision block 504, the certificate re-download/print/email page is displayed in block 518. A warning message can be displayed to the user at this time indicating that he or she has already downloaded/printed/e-mailed the certificates. The user can also be prompted for a confirmation that he or she really wants to redownload/reprint/re-e-mail the certificates. The user may then select to either re-download his or her certificates in electronic form or reprint the certificates at his or her designated printer, or re-e-mail the certificates. The reissued certificates will be identical to those previously issued. If the user selects print certificates, as determined in decision block 520, the server 102 (FIG. 1) will retrieve the certificate information from the database 104 (FIG. 1) in block 522, and recreate and resend the reissued certificates to the user's designated printer in block 524. Thereafter, the user exits the download/print process in block 516 and is returned back to the main process in FIG. 3, block 304 or 306. If, however, the user selects download certificates, as determined in decision block 520, the server 102 (FIG. 1) will retrieve the certificate information from the database 104 (FIG. 1) in block 526, and recreate and resend the reissued certificates to the user typically via e-mail in block 528. The present invention may enable the user to select to whom the certificates are sent and how many certificates are sent. Alternatively, the present invention may restrict the user to specific email recipients (for example, the creator/presenter of the certificate and the person named on the certificate) and limit the number of reissued certificates sent. Thereafter, the user exits the download/print process in block 516 and is returned back to the main process in FIG. 3, block 304 or 306.

Now referring to FIG. 6, a flow chart depicting the redemption process 600 of the user recognition system in accordance with one embodiment of the present invention is shown. The redemption process (see block 316 of FIG. 3) begins in block 602. The certificate redemption page 208 (FIG. 2) is displayed in block 604. The user then enters the certificate number, issuer ID number, recipient ID number and recipient e-mail address in block 606. The server 102 (FIG. 1) uses the certificate number entered by the user to check the database 104 (FIG. 1) to determine if the information supplied by the user is invalid, meaning that the certificate ID does not match a currently active certificate, or the issuer ID does not correspond to the user to which the certificate number was issued to, or the recipient ID is incorrect. If the information supplied by the user is invalid, as determined in decision block 608, an invalid data message is displayed in block 610 and the process returns to block 606 where the user can reenter the data.

If, however, the information supplied by the user is valid, as determined in decision block 608, the server 102 (FIG. 1) determines whether the certificate has already been redeemed in block 612. If the certificate has already been redeemed, a message indicating that the certificate has already been redeemed is displayed in block 614 and the process returns to block 606 where the user can reenter the data. If, however, the certificate has not been redeemed, as determined in decision block 612, a successful redemption message is displayed in block 616 and the redemption information is stored in block 618 for listing in database 104 (FIG. 1). The redemption information may include the date and time that the certificate was redeemed, the first user (creator's ID and /or e-mail address), the second user (recipient's ID and/or e-mail address), and other data that can be used in statistical analysis. Thereafter, the user exits the redemption process in block 620 and is returned back to the main process in FIG. 3, block 304 or 306.

FIG. 7 is a flow chart depicting the report process 700 of the user recognition system in accordance with one embodiment of the present invention. The report process (see block 322 of FIG. 3) begins in block 702. The server 102 (FIG. 1) determines which reports are available to a given user in block 704 via a security profile assigned to the user and stored in the database 104 (FIG. 1). The appropriate report selection page 210 (FIG. 2) is then displayed in block 706. Depending on the type of report selected, the user may have the opportunity to select report options or customize a selected report in block 708. Some reports, such as monthly winners (first and second users) or whether users receiving their certificates have redeemed them, may be available to all users, whereas other reports, such as detailed redemption reports may only be available to executives. The report option may include a time period for the report, such as this month, last month, this year, etc. The report option may also include winners lists, issuer or redeemer lists by department, company, organization, etc. Once a user selects an available report and report options, the server 102 (FIG. 1) delivers the report to the user via the report page 212 (FIG. 2) in block 710. Reports may be printed, saved to file or e-mailed to someone in block 711. Thereafter, the user exits the report process in block 712 and is returned back to the main process in FIG. 3, block 304 or 306.

FIG. 8 is an example of a page containing certificates printed out in accordance with one embodiment of the present invention. Each certificate 800-818 has a unique certificate number 820-838, the name of the user 840 to which the certificate 800-818 was issued to, and that user's ID 842. As previously described, this information is used to valid the certificates 800-818 and prevent fraud. Each certificate 800-818 may include the name of the user recognition program 844 and the logo or name of the company or organization 846 sponsoring the user recognition program. In addition, each certificate 800-818 may include a place 848 to indicate the name of the recipient user, a message 850 to the recipient and instructions 852 on how to redeem the certificate. Note that the message 850 printed on the certificate 800-818 could be selected by the issuing user during the download/print certificate process (FIG. 3, block 310 and FIG. 5). The issuing user can select from a list of preset messages that are maintained in a table in the database or enter their own personalized message. Note that the present invention is not restricted to the specific certificate form, the number of certificates, or the certificate information depicted in FIG. 8.

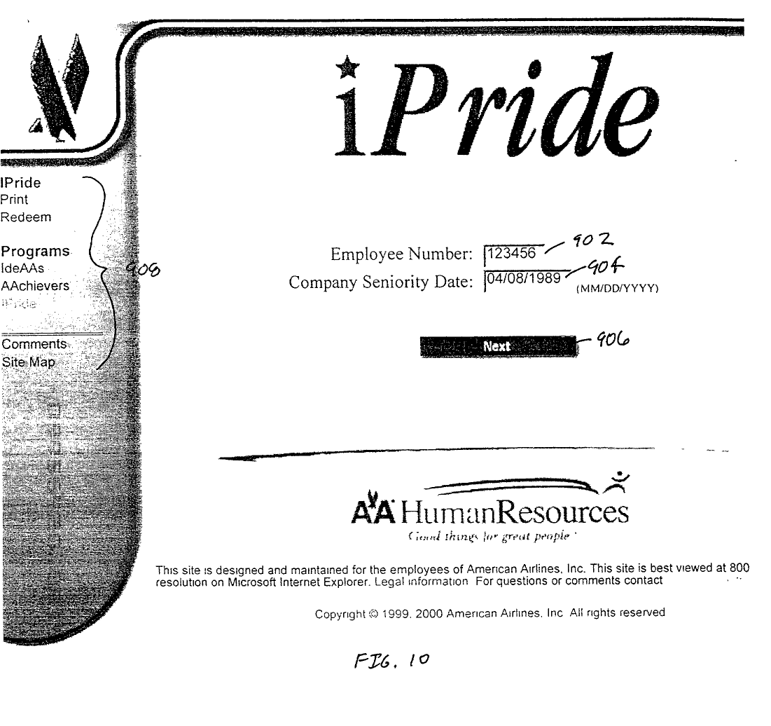

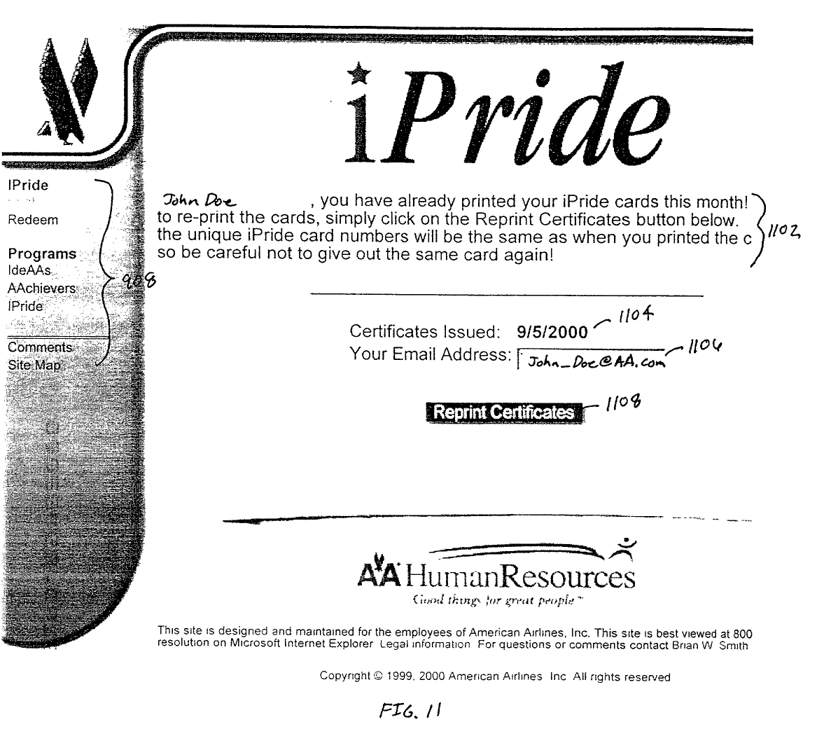

FIG. 9 is an example of a user login page 204 (FIG. 2) in accordance with one embodiment of the present invention. As shown in this example, the user ID is the employee number 902 and the password is the company seniority date 904. The initial password rules are set by the implementing group. Additionally, the implementing group may elect to have only one (1) password required at the company's or organization's portal. The user submits the employee number 902 and company seniority date 904 by clicking on the Next button 906. Other pages can be displayed by clicking on the buttons in area 908. FIG. 10 is an example of a user login page 204 (FIG. 2) containing data provided by the user in accordance with one embodiment of the present invention. After initial login, the system will prompt the user to set-up a new password.

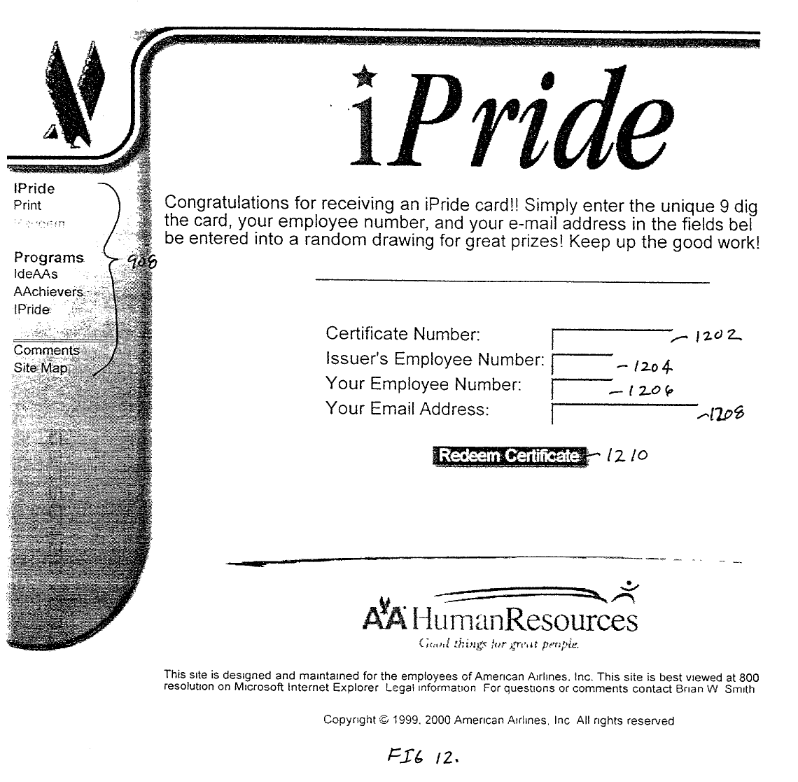

FIG. 11 is an example of a certificate re-download/print/e-mail page 518 (FIG. 5) in accordance with one embodiment of the present invention. The text in block 1102 informs the user (John Doe) that he has already printed his certificates for this month and provides him with instructions on how to print out duplicate certificates. The date the certificates were issued is shown in field 1104 and the user's e-mail address is shown in field 1106. The user can reprint the certificates by clicking on the Reprint Certificates button 1108. Other pages can be displayed by clicking on the buttons in area 908.

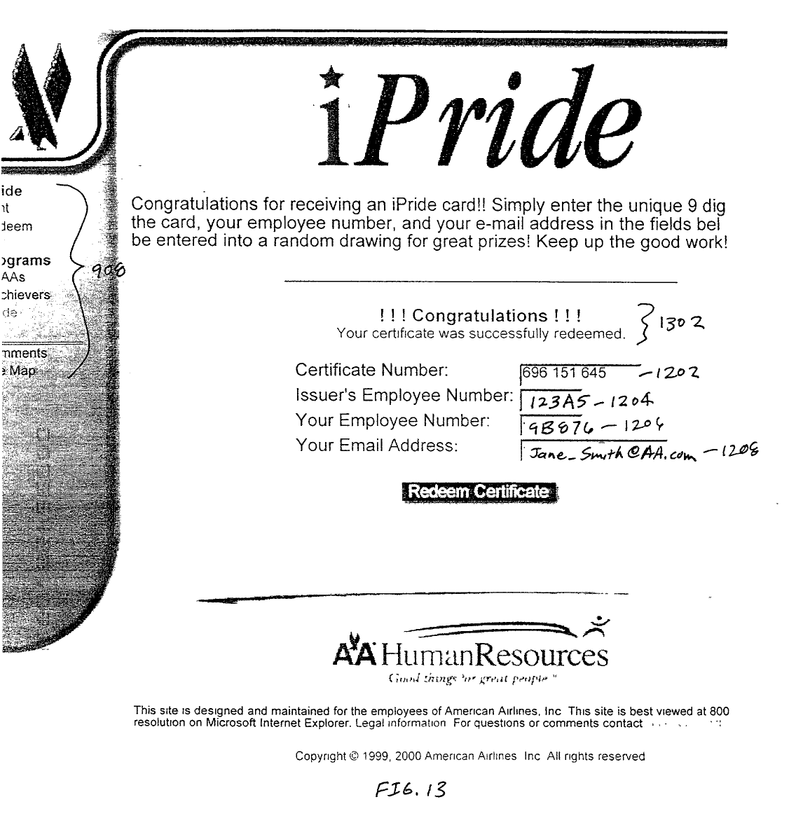

FIG. 12 is an example of a certificate redemption page 208 (FIG. 2) in accordance with one embodiment of the present invention. In order to redeem a certificate in this example, the user enters the certificate number 1202, the issuer's employee number 1204, the recipient's employee number 1206 and the recipient's e-mail address 1208. The user redeems the certificate by clicking on the Redeem Certificate button 1210. Other pages can be displayed by clicking on the buttons in area 908.

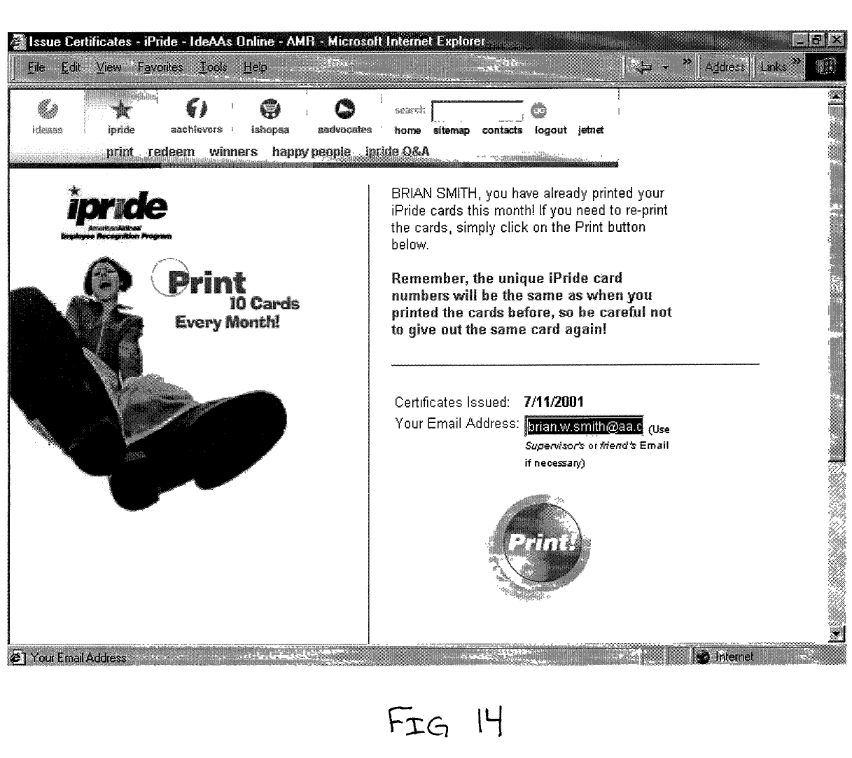

FIG. 13 is an example of a certificate redemption page 616 (FIG. 6) showing a successful redemption of a certificate in accordance with one embodiment of the present invention. After a successful redemption of a certificate, a message indicating successful redemption is display in text block 1302. The certificate number 1202, the issuer's employee number 1204, the recipient's employee number 1206 and the recipient's e-mail address 1208 entered by the user are also displayed. Winners may be notified that they have won, for a given period, via electronic means. All employees may check the periodic winners reports via this website. Other pages can be displayed by clicking on the buttons in area 908. Administrative functions, such as resetting passwords, retrieving forgotten passwords, contact information, program rules and help may also be accessible from screens such as those depicted in FIGS. 9 through 13.

FIGS. 14 and 15 illustrate informational pages in accordance with one embodiment of the present invention. FIG. 14 illustrates a web page that informs the user that the maximum number of certificates for a given period (in this case, 10 per month) have already been printed. FIG. 15 illustrates a web page displaying a list of winners, both first users (creators/presenters) and second users (redeemers) are included.

While specific alternatives to steps of the invention have been described herein, additional alternatives not specifically disclosed but known in the art are intended to fall within the scope of the invention. Thus, it is understood that other applications of the present invention will be apparent to those skilled in the art upon the reading of the described embodiment and a consideration of the appended claims and drawings.

What is claimed is:

1. A method for recognizing users comprising the steps of:
creating one or more certificates, each certificate having a certificate identifier;
issuing the one or more certificates to a first user having a first user identifier;
storing the certificate identifier and the first user identifier for each certificate issued to the first user in a database;
redeeming at least one of the certificates given to a second user having a second user identifier by the first user; and
storing the second user identifier with the certificate identifier in the database for each certificate given to the second user.

2. The method as recited in claim 1, further comprising the step of determining whether one of the certificates is valid before the certificate can be redeemed.

3. The method as recited in claim 1, further comprising steps of:
selecting a redeemed certificate; and
recognizing the first user and second user associated with the selected redeemed certificate.

4. The method as recited in claim 3, wherein the redeemed certificate is selected randomly.

5. The method as recited in claim 3, wherein the redeemed certificate is selected from less than a total number of redeemed certificates.

6. The method as recited in claim 1, wherein only a specified number of certificates are be issued to the first user during a specified time period.

7. The method as recited in claim 1, further comprising the step of authenticating the identity of the first user before any certificates are issued to the first user.

8. The method as recited in claim 1, further comprising the step of authentication the identity of the second user before any certificates are redeemed by the second user.

9. The method as recited in claim 1, further comprising the step of selecting a message to be imprinted on each certificate.

10. The method as recited in claim 1, wherein the first user and second user are employees.

11. The method as recited in claim 1, wherein the first user is employed by a vendor.

12. The method as recited in claim 1, wherein the first user is employed by an organization having a common goal with one or more other organizations.

13. The method as recited in claim 1, wherein the first user and second user are members of a predesignated group.

14. The method as recited in claim 1, further comprising the step of specifying a message to be imprinted on the certificate.

15. A computer program embodied on a computer readable medium for recognizing users comprising:
a code segment for creating one or more certificates, each certificate having a certificate identifier;
a code segment for issuing the one or more certificates to a first user having a first user identifier;
a code segment for storing the certificate identifier and the first user identifier for each certificate issued to the first user in a database;
a code segment for redeeming at least one of the certificates given to a second user having a second user identifier by the first user; and
a code segment for storing the second user identifier with the certificate identifier in the database for each certificate given to the second user.

16. The computer program as recited in claim 15, further comprising a code segment for determining whether one of the certificates is valid before the certificate can be redeemed.

17. The computer program as recited in claim 15, further comprising:
a code segment for selecting a redeemed certificate; and
a code segment for recognizing the first user and second user associated with the selected redeemed certificate.

18. The computer program as recited in claim 17, wherein the redeemed certificate is selected randomly.

19. The computer program as recited in claim 17, wherein the redeemed certificate is selected from less than a total number of redeemed certificates.

20. The computer program as recited in claim 15, wherein only a specified number of certificates are be issued to the first user during a specified time period.

21. The computer program as recited in claim 15, further comprising a code segment for authenticating the identity of the first user before any certificates are issued to the first user.

22. The computer program as recited in claim 15, further comprising a code segment for authentication the identity of the second user before any certificates are redeemed by the second user.

23. The computer program as recited in claim 15, further comprising a code segment for selecting a message to be imprinted on each certificate.

24. The computer program as recited in claim 15, wherein the first user and second user are employees.

25. The computer program as recited in claim 15, wherein the first user is employed by a vendor.

26. The computer program as recited in claim 15, wherein the first user is employed by an organization having a common goal with one or more other organizations.

27. The computer program as recited in claim 15, wherein the first user and second user are members of a predesignated group.

28. The computer program as recited in claim 15, further a code segment for specifying a message to be imprinted on the certificate.

29. A system for recognizing users comprising:
a server computer;
a database communicably linked to the server computer;
at least one user computer;
a network communicably linking the user terminal to the server computer;
the server computer creates one or more certificates, each certificate having a certificate identifier, issues the one or more certificates to a first user having a first user identifier via one of the user computers, stores the certificate identifier and the first user identifier for each certificate issued to the first user in the database, redeems at least one of the certificates given to a second user having a second user identifier by the first user via one of the user computers, and stores the second user identifier with the certificate identifier in the database for each certificate given to the second user.

30. The system as recited in claim 29, wherein the server computer further determines whether one of the certificates is valid before the certificate can be redeemed.

31. The system as recited in claim 29, wherein the server computer further selects a redeemed certificate, and recognizes the first user and second user associated with the selected redeemed certificate.

32. The system as recited in claim 31, wherein the redeemed certificate is selected randomly.

33. The system as recited in claim 31, wherein the redeemed certificate is selected from less than a total number of redeemed certificates.

34. The system as recited in claim 29, wherein the server computer further only issues a specified number of certificates to the first user during a specified time period.

35. The system as recited in claim 29, wherein the server computer further authenticates the identity of the first user before any certificates are issued to the first user.

36. The system as recited in claim 29, wherein the server computer further authenticates the identity of the second user before any certificates are redeemed by the second user.

37. The system as recited in claim 29, wherein the first user specifies a message to be imprinted on each certificate.

38. The system as recited in claim 29, wherein the first user and second user are employees.

39. The system as recited in claim 29, wherein the first user is employed by a vendor.

40. The system as recited in claim 29, wherein the first user is employed by an organization having a common goal with one or more other organizations.

41. The system as recited in claim 29, wherein the first user and second user comprise members of a predesignated group.
